(19) United States
(12) Patent Application Publication
(10) Pub. No.: US 2026/0079925 A1
(43) Pub. Date: Mar. 19, 2026

(54) RETRAINING SMALL LANGUAGE MODELS USING LLM-BASED REASONING ON USER-GENERATED PREDICTION CHECKS

(71) Applicant: Schlumberger Technology Corporation, Sugar Land, TX (US)

(72) Inventors: Prashanth Pillai, Pune (IN); Vikrant Rangnekar, Maharashtra (IN)

(21) Appl. No.: 19/328,589

(22) Filed: Sep. 15, 2025

(30) Foreign Application Priority Data
Sep. 13, 2024 (IN) 202411069440

(51) Int. Cl. G06F 16/3329; G06F 16/242

(52) U.S. Cl. CPC G06F 16/243; G06F 16/3329

(57) ABSTRACT

A large language model (LLM) receives a prediction set extracted from a raw data source, and binary feedback labels labeling respective predictions of the prediction set. The LLM generates an explanation set, including explanations of the binary feedback labels of the predictions, based on the raw data source of the prediction set. The LLM further generates a set of attribute extraction instructions, using the explanation set and the prediction set. The set of attribute extraction instructions includes attribute extraction instructions for a particular attribute across a multitude of raw data sources. Training instances are generated from the set of attribute extraction instructions, having attributes, attribute values and extraction instructions. The training instances are annotated with an output probability distributions of the extracted attributes. An attribute extraction model is further trained with the annotated training dataset and deployed for future attribute extractions from raw data sources.

### CROSS-REFERENCE TO RELATED APPLICATIONS

This application claims benefit to India Application No. 202411069440, filed in India on Sep. 13, 2024, and which is incorporated herein by reference.

### BACKGROUND

Oil and gas companies rely on technical reports to support subsurface interpretation workflows such as well planning, logging, seismic analysis, and petrophysical modeling. The technical reports contain valuable factual information embedded in unstructured formats, including drilling logs, production summaries, and completion reports. Extracting structured data from these documents may be performed manually, which is time-consuming, error-prone, and resource-intensive. Machine learning models may automate this process, extracting attributes, such as well depth, formation type, and event timelines from domain-specific, often unstructured reports in esoteric formats. Due to the complexity and variability of domain-specific language in the source documents, machine-learning-based attribute extraction may produce incorrect or ambiguous predictions.

A challenge arises in the retraining of these models using user feedback, to improve the performance of the machine learning models. Domain experts providing feedback may typically provide binary feedback (e.g., accepting or rejecting predictions), but may not supply detailed explanations due to time constraints. The limited feedback may be insufficient for conventional retraining workflows requiring richly annotated datasets. A challenge exists in adding capabilities to machine-learning models to reason over user feedback and generate annotated training data without manual intervention.

### SUMMARY

In general, a large language model (LLM) receives a prediction set, extracted from a raw data source, and binary feedback labels labeling respective predictions of the prediction set. The LLM generates an explanation set, including explanations of the binary feedback labels of the predictions, based on the raw data source of the prediction set. The LLM further generates a set of attribute extraction instructions, using the explanation set and the prediction set. The set of attribute extraction instructions includes attribute extraction instructions for a particular attribute across a multitude of raw data sources. Training instances are generated from the set of attribute extraction instructions, having attributes, attribute values and extraction instructions. The training instances are annotated with an output probability distributions of the extracted attributes. An annotated training dataset is obtained in this manner. An attribute extraction model is further trained with the annotated training dataset and deployed for future attribute extractions from raw data sources.

Other aspects of one or more embodiments will be apparent from the following description and the appended claims.

### BRIEF DESCRIPTION OF DRAWINGS

FIG. 1 shows a computing system, in accordance with one or more embodiments.

FIG. 2 shows a flowchart of a method, in accordance with one or more embodiments.

FIG. 3 shows an example, in accordance with one or more embodiments.

FIG. 4 shows an example, in accordance with one or more embodiments.

FIG. 5 shows an example, in accordance with one or more embodiments.

FIGS. 6.1 and 6.2 show a computing system, in accordance with one or more embodiments.

Like elements in the various figures are denoted by like reference numerals for consistency.

### DETAILED DESCRIPTION

One or more embodiments include a method for automatically generating an annotated dataset from user feedback, for retraining or fine-tuning an attribute extraction model to perform attribute extraction from a pool of raw data sources. The retraining encompasses training the attribute extraction model to search and retrieve data from specific locations in raw data sources, including semantic and physical locations for attribute values. This enables the model to learn not only what to extract, but also where to look within complex, domain-specific documents such as drilling reports, production summaries, and completion logs.

The method begins with a prediction phase, in which a deployed attribute extraction model generates predictions from raw data. The predictions are presented to a domain user through a user interface, where the user may provide binary feedback indicating whether each prediction is correct or incorrect. In one or more embodiments, the feedback is stored along with contextual information in a data repository. A reasoning phase follows, in which a large language model (LLM) analyzes the predictions and feedback and generates explanations for the acceptance or rejection of the predictions. In an instruction tuning, or generation phase, the explanations may be used to generate attribute extraction instructions spanning multiple data sources. The attribute extraction instructions may guide how a particular attribute may be extracted from multiple similar data sources.

In one or more embodiments, the LLM may use the attribute extraction instructions to generate training instances, each containing an attribute, the attribute's value, and reference metadata indicating the location of the value in the raw data, in a data annotation phase. The training instances may be annotated with output probability distributions. The annotated training instances form a training dataset used to retrain the attribute extraction model using a knowledge distillation technique. The retraining may involve computing loss and divergence functions and updating model parameters using gradient-based optimization. Once retrained, the model is deployed to improve future predictions, enabling continuous learning from user feedback with minimal manual intervention.

The invention introduces a framework that uses a large language model (LLM) to automatically generate explanations, extraction instructions, and annotated training instances from raw data and binary feedback. The framework facilitates continuous improvement and successive deployments of trained attribute extraction model instances with minimal human effort.

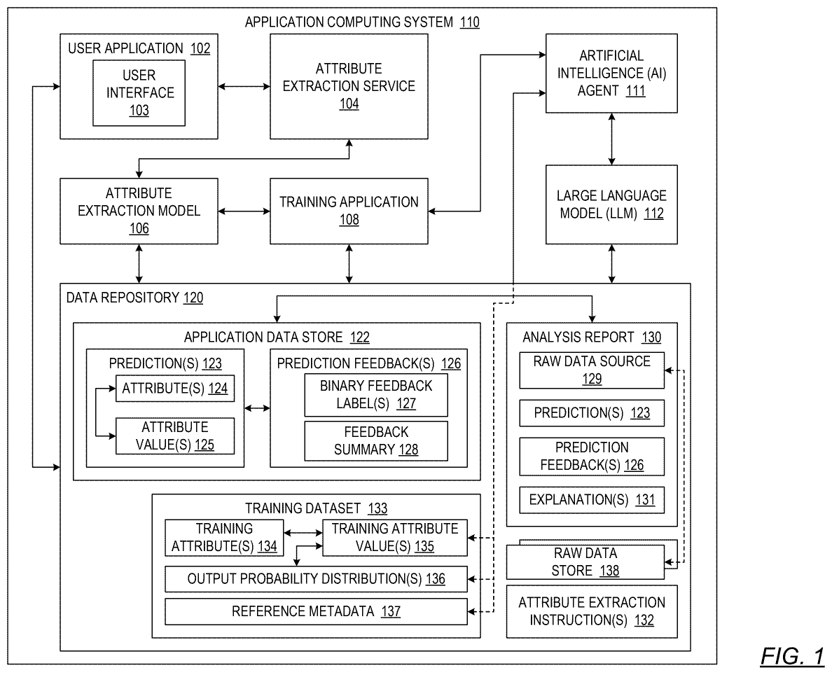

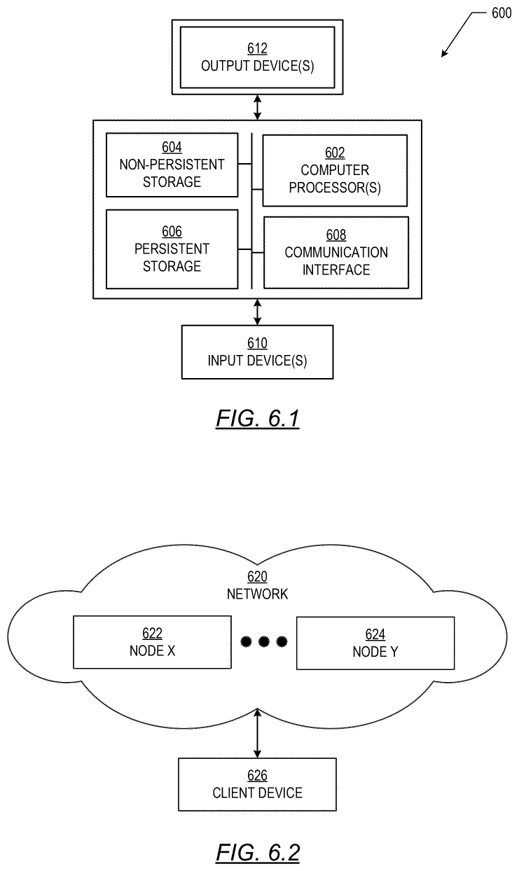

Attention is now turned to the figures. FIG. 1 shows a computing system, in accordance with one or more embodiments. The system shown in FIG. 1 may include an application computing system (110). The application computing system (110) is one or more computer processors, data repositories, communication devices, and supporting hardware and software. The application computing system (110) may be in a distributed computing environment. The application computing system (110) includes a computer processor. The computer processor is one or more hardware or virtual processors which may execute computer-readable program code that defines one or more applications, such as the user application (102), the attribute extraction service (104), the attribute extraction model (106), the training application (108), the artificial intelligence (AI) agent (111), and the large language model (LLM) (112). An example of the computer processor is described with respect to the computer processor(s) (602) of FIG. 6.1. Thus, the application computing system (110) is configured to execute one or more applications, such as the user application (102), the attribute extraction service (104), the attribute extraction model (106), the training application (108), the AI agent (111), and the LLM (112). An example of a computer system and network that may form the application computing system (110) is described with respect to FIG. 6.1 and FIG. 6.2.

The system shown in FIG. 1 includes a data repository (120). The data repository (120) is a type of storage unit or device (e.g., a file system, database, data structure, or any other storage mechanism) for storing data. The data repository (120) may include multiple different, potentially heterogeneous, storage units and/or physical storage devices.

The data repository (120) may store all structured and unstructured data used throughout the system. The data repository (120) includes an application data store (122). The application data store (122) includes data retrieved by the user application (102) from the raw data store (138). The raw data store (138) may include a multitude of raw data source(s) (129). The application data store (122) further includes data entered by a user of the user application (102). As shown in FIG. 1, the application data store (122) further includes prediction(s) (123). The prediction (123) further includes an attribute (124), and corresponding attribute values (125). A prediction (123) may be extracted from one or more raw data sources (129) of the raw data store (138), by the attribute extraction service (104), using the attribute extraction model (106).

By way of example, the user application (102) may be an application for inspection of well data. A domain user may request well data for a particular well from the user application (102). A domain user refers to personnel of an organization in which the user application (102) is deployed. Examples of user applications (102) may be various applications pertaining to production, prospecting, and operations of oil-and-gas production sites. Thus domain users may constitute diverse personnel working in oil-and-gas production sites, remote operations and diagnostics centers, downstream operations, etc.

The attribute extraction service (104) may retrieve the well data from a well log corresponding to the particular well. The well log may be a document report using natural language sentences. The well log serves as the raw data source (129) for the well data. The attribute extraction service (104) may invoke the attribute extraction model (106) to read the well log and extract the well data. The attribute extraction model (106) may extract one or more attributes of well data, and corresponding attribute values from the well log. An attribute (124) and corresponding attribute value (125) may constitute a prediction (123) in a set of predictions. A set of predictions of attributes and attribute values extracted from the well log may be presented to the domain user in the user application (102).

The application data store (122) further includes prediction feedback (126). The prediction feedback (126) represents the response by the domain user to the extracted predictions (123). Continuing with the previous example, the domain user of the user application (102) may accept or reject a particular prediction, via the user interface (103). For example, a prediction of an attribute “Depth” and attribute value 5000 m may be acceptable to the user and may be marked as “accepted,” or “correct,” or “true,” or other indicative binary values. The prediction may be displayed alongside a section of the well log that includes the attribute and attribute value. On the other hand, the prediction may not comply with the user's intrinsic knowledge or expectations of the particular well. The prediction may be extracted from only a partial computation (e.g., plug depth instead of total depth) the domain user may reject the prediction. In this case, the user may mark the prediction as “rejected,” or “error,” or “false” or other indicative binary values, and provide a summary of why the prediction is rejected. Thus, the binary feedback labels (127), and feedback summaries (128) of the prediction feedback (126) represent the response, or feedback by the domain user to/of the extracted predictions (123).

The data repository (120) further includes one or more analysis reports (130). The analysis report (130) may correspond to a particular raw data source (129). The raw data source (129) may be one of a multitude of raw data sources in the raw data store (138). The analysis report (130) may be generated by the LLM (112), in response to being invoked by the AI agent (111). In one or more embodiments, the AI agent (111) may invoke the LLM (112) to generate the analysis report identifying at least a reason that a prediction (123) was marked as correct or as an error by the domain user. The input provided to the LLM (112) may include the predictions (123) and prediction feedback (126). The LLM (112) may generate one or more explanations (131) corresponding to the predictions (123) and prediction feedback (126) in the context of the raw data source (129). By way of example, the LLM (112) may generate an explanation: “The depth extracted was the plug depth from the well log. The total depth is required and may be found in the section marked ‘Total depth,’” in response to the prediction and prediction feedback of the previous example. Thus, the analysis report includes predictions and explanations pertaining to a particular raw data source (129).

A multitude of analysis reports (130) may be stored, with predictions and explanations pertaining to respective raw data source(s) (129). From the multitude of analysis reports (130), attribute extraction instructions (132) may be synthesized, pertaining to a particular attribute, across the multitude of raw data sources (129). An attribute extraction instruction is a synthesis, or aggregation of instructions to extract a particular attribute from a compendium of diverse raw data sources. In other words, the synthesized, or aggregated attribute extraction instruction may direct the LLM to obtain an attribute A from data source A by extracting field value A. The synthesized, or aggregated attribute extraction instruction may further include a directive to obtain field value B from data source B. The synthesized, or aggregated attribute extraction instruction may further direct the LLM to compute a sum of field value A and field value B and validate the result against field C from data source C. If valid, the result may be taken to be the attribute value of attribute A. Thus, the synthesized, or aggregated attribute extraction instruction may extract one or more field values from one or more raw data sources, and/or combine the field values in diverse ways to extract an attribute value for a particular attribute.

In another example, the attribute for total depth may be obtained from a well log. The total depth may be further validated or shown as a computation of diverse well data, present in another raw data source. Thus, a synthesized attribute extraction instruction (132) for well depth, may include an instruction of how to obtain the well depth from a well log, and how to validate the well depth from a computation of well characteristic's field values (e.g., plug depth) obtained from database records. Accordingly, the attribute extraction instruction (132) for a particular attribute may include aggregated instructions, corresponding to respective raw data sources, which store the particular attribute, or field values that may be combined to obtain the attribute value for the particular attribute. The attribute extraction instruction (132) may further include reconciliation measures for the attribute values stored in the respective raw data sources. The raw data sources (129) may include documents, relational databases, spreadsheets, graph databases, etc.

The data repository (120) further includes a raw data store (138). The raw data store (138) is a collection of raw data sources (129). Each raw data source (129) may be machine-readable and understandable by the LLM (112). For example, the raw data store (138) may include logical data sources such as documents, images, database schemas and records, graph databases, etc. A logical data source of the raw data store (138) is shown in FIG. 1 as raw data source (129).

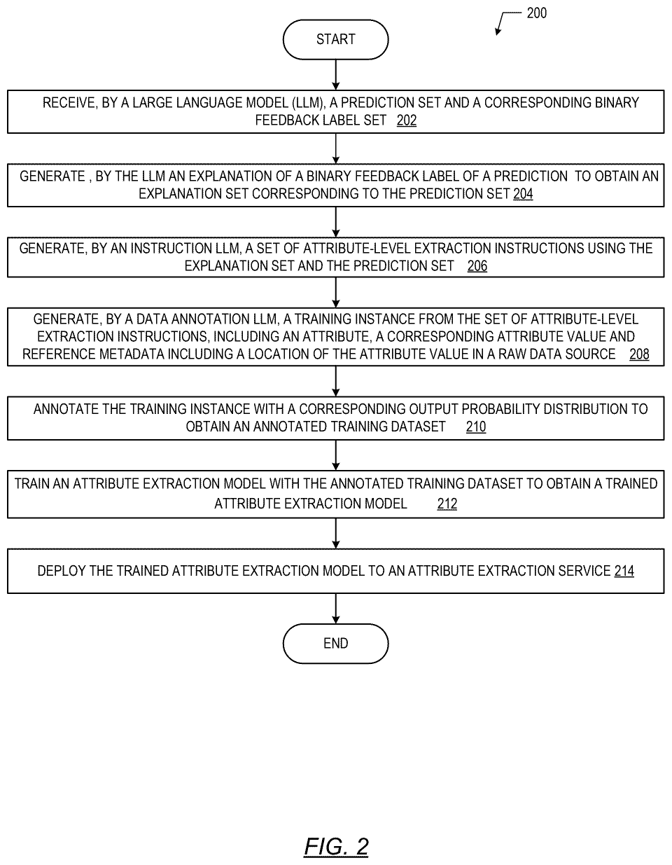

The data repository (120) further includes one or more training datasets. A training dataset (133) further includes training attributes (134) and corresponding training attribute values (135). Additionally, the training dataset (133) may include an output probability distribution (136) generated by the LLM (112) when retrieving the training attribute value (135), from the raw data sources (129) in the raw data store (138). The retrieval by the LLM (112) may be in accordance with the attribute extraction instruction (132) for the particular training attribute (134). The training dataset (133) may further include reference metadata (137) corresponding to the training attribute (134). The reference metadata (137) encompasses semantic and physical location information of the training attribute (134) across the respective raw data sources from whence the training attribute value (135) corresponding to the training attribute (134) was retrieved. For example, the reference metadata (137) may include information: “Well log: Section: Total depth; Table: well_characteristics: field: plug depth; field: total depth.” The reference metadata thus indicates a semantic location (a section titled “Total depth”) and a logical location, namely, table well characteristics, and fields plug depth, and total depth. A detailed description of the manner in which the training dataset (133) may be generated is provided in reference to the method of FIG. 2.

The application computing system (110) further includes a user application (102). In one or more embodiments, the user application (102) may be a web-based client application, operating within a web browser. Other embodiments of the user application (102) may include native desktop applications, mobile applications, remote desktop clients, etc. The user application (102) serves as a point of interaction for users to engage with the application computing system (110), more particularly, as an entry point for initiating a prediction phase of operations of the application computing system (110). In an example implementation, the user application (102) may be implemented as a web-based dashboard using technologies like REACT® software or ANGULAR® software. The user application (102) provides a user interface (103). Through the user interface (103), users may view predictions generated by the attribute extraction service (104) and provide binary feedback indicating acceptance or rejection of extracted attributes. Further, the users may submit feedback summaries, including reasons or explanations as to the acceptance or rejection of a particular extracted attribute. The feedback summaries serve as additional rationales to be incorporated into reasoning processes of the LLM and retraining or fine-tuning of the attribute extraction model (106).

The application computing system (110) further includes an attribute extraction service (104). The attribute extraction service (104) is software or application-specific hardware, which, when executing on a computer processor is configured to invoke the deployed attribute extraction model (106) to process raw data and generate structured predictions (123). The structured predictions (123) include attributes (124) and corresponding attribute values (125), which are presented to the user via the user application (102). The attribute extraction service (104) may be implemented as a software service invoked via a RESTful API.

The application computing system (110) further includes an attribute extraction model (106). In one or more embodiments, the attribute extraction model (106) may be a small language model trained to extract structured attributes and corresponding attribute values from diverse raw data sources. The raw data sources may include unstructured documents, structured logs, relational databases, spreadsheets, graph databases, etc. The attribute extraction model (106) may be configured to identify both the semantic meaning of attributes and the physical location of attribute values within a raw data source, for precise and context-aware extraction of attribute values.

In one or more embodiments, the attribute extraction model (106) may be implemented as a transformer-based neural network with a reduced number of layers and parameters compared to large language models. As a general overview, small language models are optimized for task-specific performance and efficient deployment in real-time applications and environments with limited computational resources. Small language model architectures may include encoder-only models such as RoBERTa model, decoder-only models such as GPT model variants, or encoder-decoder models such as T5 model. The attribute extraction model (106) may be trained or fine-tuned using annotated datasets generated by a large language model. Thus, the attribute extraction model (106) may inherit domain-specific reasoning from the LLM (112) while maintaining a lightweight footprint.

The attribute extraction model (106) may be exposed as a machine learning endpoint and invoked during the prediction phase to generate attribute-value pairs from raw data as predictions. The predictions may be presented to users for validation and used as input for subsequent reasoning and retraining workflows.

The application computing system (110) further includes a training application (108). The training application (110) is software or application-specific hardware, which when executed on the computer processor, manages the retraining of the attribute extraction model using annotated datasets. The training application (108) may be configured to retrieve training data and update the attribute extraction model (106) parameters. The parameters may be updated by computing loss functions and divergence metrics between predicted and target probability distributions. The training application (108) may store and retrieve training datasets in the data repository (120). The training application (108) may be implemented using machine learning frameworks such as PYTORCH® software or TENSORFLOW® software. The training application (108) may support fine-tuning and knowledge distillation workflows.

The application computing system (110) further includes an artificial intelligence (AI) agent (111). An AI agent, in general terms, is a software-based entity that autonomously performs tasks by perceiving its environment, reasoning about the information the agent receives, and taking actions to achieve specific goals. AI agents may have data ingestion, decision-making logic, and interaction capabilities. AI agents may be powered by machine learning or large language models. AI agents may operate continuously, adapt to new inputs, and coordinate complex workflows without direct human intervention. Accordingly, the AI agent (111) orchestrates the reasoning and data annotation phases. The AI agent (111) may retrieve predictions (123), binary feedback labels (127), and feedback summaries (128) from the application data store (122) and invoke the large language model (112) to generate explanations (131) and attribute extraction instructions. The AI agent (111) may further compile analysis reports and construct annotated training datasets that include reference metadata and output probability distributions.

The AI agent (111) may invoke the LLM (112) in diverse personas, or roles, corresponding to diverse phases of a chain-of-thought reasoning process. In the context of the system shown in FIG. 1, the chain-of-thought reasoning process refers to a structured, multi-phase workflow executed by the AI agent (111) in coordination with the large language model (LLM) (112). The chain-of-thought process iteratively refines and improves the performance of the attribute extraction model through reasoning, instruction tuning, and data annotation. The chain-of-thought reasoning process unfolds across three phases: the reasoning phase, the instruction tuning phase, and the data annotation phase.

In the reasoning phase, the AI agent (111) may invoke the LLM in a reasoning persona, or role, prompting the LLM (112) to analyze the user feedback of the extracted attributes. The LLM (112) may generate explanations (131) that detail the reason of acceptance/rejection of attributes and corresponding attribute values by the domain user, based on the raw data source and user feedback. The explanations (131) may be compiled by the AI agent (111) into the analysis reports (130) which serve as the basis for subsequent instruction tuning and data annotation.

In the instruction tuning phase, the AI agent (111) may invoke the LLM (112) in an instruction tuning persona or role. In the instruction tuning role, the LLM (112) may be provided with the analysis reports (130). The LLM (112) may aggregate and compile instructions for a particular attribute across diverse raw data sources and synthesize or generate attribute extraction instructions facilitating enhanced precision and recall of attribute value retrieval.

In the data annotation phase, the AI agent (111) may invoke the LLM as a data annotator persona or role. Accordingly, the LLM (112) may generate annotated datasets including reference metadata and output probability distributions in accordance with the attribute extraction instructions. Thus, the AI agent (111) may act as the orchestrator of the chain-of-thought reasoning process, by managing data flow, and selecting and invoking the appropriate LLM persona for each phase. In one or more embodiments, the AI agent (111) may operate in an agentic execution framework, such as LANGCHAIN® framework or LANGGRAPH® framework, for iterative reasoning and prompt refinement.

The application computing system (110) further includes a LLM (112). The LLM (112) is a transformer-based model, which can process natural language inputs, images, audio/video and generate natural language outputs, images, audio/video, etc., in response. The LLM (112) may process raw data sources (138), predictions (123), and prediction feedback (126) to generate explanations (131) and training instances. The LLM may be an off-the-shelf model such as OpenAI's GPT-5® model, Meta's LLAMA® model, or Google's GEMINI® model and may be accessed via API endpoints. Depending on the phase, the LLM may operate in different personas to support reasoning, instruction generation, and data annotation.

While FIG. 1 shows a configuration of components, other configurations may be used without departing from the scope of one or more embodiments. For example, various components may be combined to create a single component. As another example, the functionality performed by a single component may be performed by two or more components.

FIG. 2 shows a flowchart 200 of a method for generating an annotated dataset and training or fine-tuning an attribute extraction model, in accordance with one or more embodiments. The method of FIG. 2 may be implemented using the system of FIG. 1 and one or more of the steps may be performed on or received at one or more computer processors. While the various steps in the flowchart 200 are presented and described sequentially, at least some of the steps may be executed in different orders, may be combined, or omitted, and at least some of the steps may be executed in parallel. Furthermore, the steps may be performed actively or passively.

In Block 202, a prediction set, and a corresponding binary feedback label set is received by the LLM. In one or more embodiments, the prediction set may be extracted from a raw data source. The binary feedback label set may include binary feedback labels. Each binary feedback label may label a respective prediction of the prediction set. Thus, the binary feedback label set includes binary feedback labels labeling respective predictions of the prediction set.

In one or more embodiments, the prediction may be generated by a previously deployed instance of the attribute extraction model. In other words, the prediction set may be generated in a production environment, including the attribute extraction model instance, deployed to be used by the attribute extraction service. The steps of Block 202 may be considered as constituting a portion of a prediction phase of the overall workflow of the application computing system. Further, in one or more embodiments, the prediction may be presented in the user application, via the user interface. A user of the user application that requested the attribute extraction may annotate the prediction with a binary feedback label (correct or error label) indicating acceptance or rejection of the prediction of the attribute and corresponding attribute value. Thus, the attribute extraction service may obtain a binary feedback label corresponding to the prediction, including one of a correct label and an error label. The attribute extraction service may further obtain a feedback summary corresponding to the prediction. The attribute extraction service may then store the prediction, the binary feedback label, and the feedback summary in a data repository.

Notably, Blocks 204, 206, and 208 of the flowchart 200 may be representative of offline, or back-end operations of the method of FIG. 2. In other words, the steps of the aforementioned blocks may not be executed in the production system. Instead, the steps may be performed in an offline mode, using an offline instance of the attribute extraction model.

In Block 204, an explanation of a binary feedback label of a prediction is generated by the large language model. In one or more embodiments, the explanation may be generated using the prediction and the raw data source from which the prediction was extracted. An explanation set may be created, and each explanation in the set may correspond to a prediction in the prediction set. The individual explanations may provide a rationale for the acceptance or rejection of a prediction by the user. In one or more embodiments, the AI agent may generate a prompt to the LLM. The prompt may include the prediction set, the corresponding binary feedback label set, and the raw data source as prompt inputs. The instruction portion of the prompt may include a directive to generate the explanation set using the input. The instruction portion may further indicate to the LLM to assume a particular persona or role. In general, LLMs may be trained to interpret personas or roles to influence the style, tone, and extent of information revealed in a generated natural language response. Accordingly, in prompt engineering, directing an LLM to assume a persona or role may fine-tune the output to the current context.

In Block 206, a set of attribute extraction instructions is generated by the large language model. In one or more embodiments, the instructions may be generated using the explanation set and the prediction set. The instructions may span across a multitude of raw data sources, including the original raw data source. The instructions may guide how attributes should be extracted from unstructured data. In one or more embodiments, a multitude of explanation sets may be obtained. Individual explanation sets of the multitude may correspond to individual raw data sources from which the prediction set is extracted. Further, individual explanations from the multitude of explanation sets may be aggregated by individual predictions of the prediction set. For example, the multitude of explanation sets may include four explanations for prediction one, three explanations for prediction two, four explanations for prediction three, etc. The explanations across the multitude of explanation sets may be reorganized and aggregated by individual predictions, to obtain a multitude of second explanation sets. In other words, a set of four explanations for prediction one, may be a second explanation set corresponding to prediction one. The set of three explanations for prediction two may be a second explanation set corresponding to prediction two. Thus, each second explanation set corresponds to a prediction of the prediction set. Further, a prompt may be generated to the LLM. The prompt input may include the multitude of the second explanation sets, the prediction set, and the multitude of raw data sources. The prompt instruction may include a directive to generate attribute extraction instructions corresponding to attributes of individual predictions of the set of predictions. The AI agent may further include a directive to assume the persona or role of an instruction-tuner, to the LLM. The LLM may process the prompt to generate the set of attribute extraction instructions.

In Block 208, a training instance is generated by the large language model using the attribute extraction instructions. In one or more embodiments, the training instance may include a training attribute and a corresponding training attribute value. Reference metadata may also be generated, indicating locations in the raw data sources from which the training instance was extracted. The reference metadata may help the attribute extraction model learn where to look for specific information in raw data sources. In one or more embodiments, the LLM may process an attribute extraction instruction by performing operations including extracting a training instance, having a training attribute and a corresponding training attribute value, from the multitude of raw data sources. The operations may further include generating reference metadata corresponding to the training instance. The reference metadata may include locations in the multitude of raw data sources from which the training instance is extracted.

In Block 210, the training instance is annotated with an output probability distribution. In one or more embodiments, the output probability distribution may be a vector of probabilities associated with the training attribute value. In one or more embodiments, the AI agent may retrieve, from the LLM, an output probability distribution corresponding to the training instance. The AI agent may further add the output probability distribution to the training instance, to obtain the annotated training dataset.

In Block 212, the attribute extraction model is trained using the annotated training dataset. In one or more embodiments, the training process may include inputting a training attribute and its reference metadata into the model. A predicted attribute value may be obtained, and a loss function may be computed between the predicted value and the training attribute value. This loss function may be used to guide model optimization.

In one or more embodiments, the attribute extraction model may be fine-tuned with the annotated training dataset using quantization and knowledge distillation techniques. Knowledge distillation involves transferring the representational power of a larger, more capable model, such as the LLM, into the smaller attribute extraction model. Knowledge distillation may be achieved by using the training instance to obtain a target output probability distribution, which reflects the LLM's interpretation of the attribute. The attribute extraction model similarly produces a predicted output distribution for the same input. A divergence function may be computed between the target and predicted distributions. The resulting divergence value may be combined with the original loss function value to form a composite loss. The composite loss may then be used to update the model's parameters via gradient-based optimization.

Quantization is a technique applied to reduce the computational complexity of the attribute extraction model. The quantization technique entails converting model weights and activations from high-precision formats, such as 32-bit floating point, to lower-precision formats such as 8-bit integers. Quantization reduces memory usage and inference latency, for the attribute extraction model to operate efficiently in resource-constrained environments such as mobile devices or embedded systems. Quantization may be applied post-training or during training using quantization-aware methods supported by machine learning frameworks like PyTorch or TensorFlow.

Knowledge distillation and quantization may facilitate the attribute extraction model to be accurate and aligned with the reasoning of the LLM and optimized for deployment in real-world applications.

More particularly, one or more embodiments may include training the attribute extraction model by performing operations including inputting, to the attribute extraction model, a training attribute and corresponding reference metadata of the training attribute. The training attribute and the corresponding reference metadata may be obtained from a training instance of the annotated training dataset. The operations may further include obtaining, from the attribute extraction model, a predicted attribute value. The operations may further include computing a loss function of the predicted attribute value and a training attribute value corresponding to the training attribute to obtain a loss function value. The training attribute value and the training attribute may constitute the training instance. Further, a target output probability distribution may be obtained from the training instance.

A divergence function may be computed between the target output probability distribution and an output probability distribution of the attribute extraction model corresponding to the predicted attribute value. A divergence function value may be thus obtained. Further, the loss function value and the divergence function value may be combined to obtain a combined loss function value. Finally, the parameters of the attribute extraction model being trained may be updated by backpropagating gradients computed from the combined loss function value through a multitude of layers of the attribute extraction model using a gradient-based optimization function. An example of the loss function is a cross-entropy loss function. An example of the divergence function is the Kullback-Leibler divergence function. An example of the gradient-based optimization function is the Adam optimizer. Other functions may be used.

In Block 214, the trained attribute extraction model is deployed. In one or more embodiments, the deployment may make the model available for use in extracting attributes and values from new raw data sources. The model may be used in production environments to automate fact extraction tasks and improve efficiency. Thus, the attribute extraction model instance that performed the step of Block 202, may be replaced with an instance of the trained attribute extraction model. Over the course of deployment and use of the attribute extraction service, the deployed attribute extraction model instances may be replaced with successive subsequently trained attribute extraction model instances, in an ongoing loop of the reasoning, instruction tuning and dataset generation phases, effectively incorporating user feedback continuously into the deployed production system.

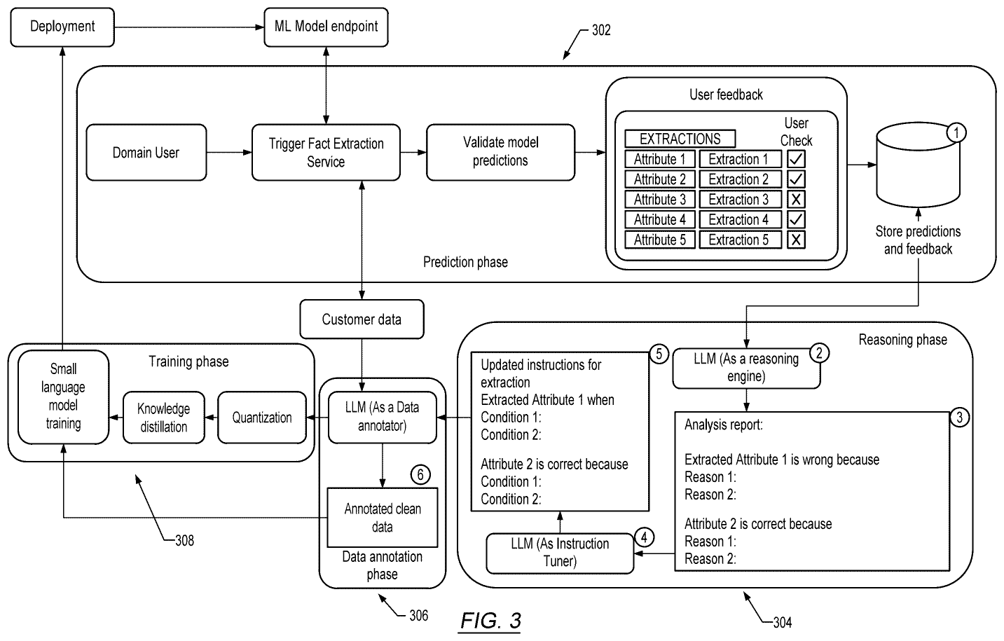

FIG. 3 shows an example implementation of the system of FIG. 1, implementing the method of FIG. 2, in accordance with one or more embodiments. The following example is for explanatory purposes only and not intended to limit the scope of one or more embodiments.

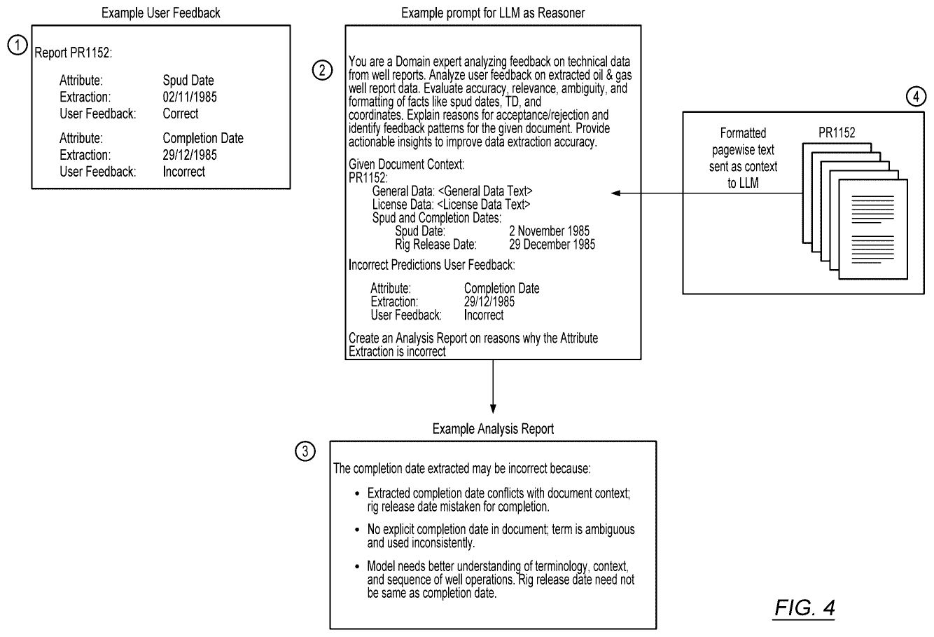

More particularly, FIG. 3 illustrates an example implementation of a system for attribute extraction using an AI agent powered by the LLM. The system included multiple phases, each contributing to the refinement and deployment of a small language model for domain-specific attribute extraction. Block 302 represents the prediction phase of the deployed system. In this phase, a domain user may interact with a user application to request extraction of one or more attributes from customer data. A fact extraction service, corresponding to the attribute extraction service, is triggered to invoke the attribute extraction model, which is a small language model trained for this purpose. The extracted attributes are presented to the domain user via a user interface. The domain user may validate the model's predictions and provide feedback regarding the accuracy and relevance of the extracted attributes. Both the predictions and the user feedback are stored in a data repository, corresponding to the application data store referenced in the system diagram. The predictions and the user feedback are stored as a report in the data repository, represented by reference numeral 1. An example of the report corresponding to reference numeral 1 is further shown in FIG. 4.

Block 304 corresponds to the reasoning phase, which is executed offline. Block 304 further includes reference numerals 2, 3, 4, and 5, representing the inputs and outputs to the individual blocks of the reasoning phase. In the reasoning phase, the AI agent utilizes the LLM to perform chain-of-thought reasoning over the stored predictions and feedback. Reference numeral 2 in Block 304 represents the input provided to the LLM acting as a reasoning engine. A corresponding example of the input represented by reference numeral 2 is shown in FIG. 4.

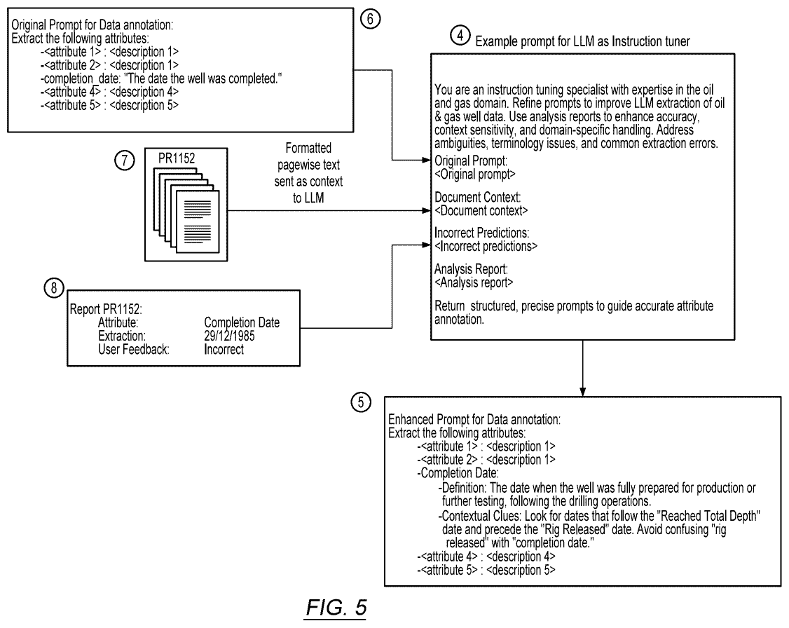

The output of the LLM is shown in the block referred by reference numeral 3. Here, the LLM generates an analysis report that includes explanations for certain attributes being correctly or incorrectly extracted, based on specific conditions derived from the domain context. The analysis report represented by reference numeral 3 is passed to the LLM acting as an instruction tuner. During instruction tuning, the LLM updates the extraction instructions based on the reasoning outputs, refining the logic and heuristics used by the attribute extraction model. Reference numeral 4 represents all of the inputs to the LLM acting as an instruction tuner. The inputs include the analysis report of reference numeral 3, and further, additional inputs including document context, an original prompt for data annotation and an instruction to the LLM acting as the instruction tuner. An example of the input of reference numeral 4 is shown in FIG. 5.

Reference numeral 5 in Block 304 shows the LLM's (in the role of instruction tuner) updated instructions for extraction of diverse attributes. The instructions include condition-based extraction instructions. Reference numeral 5 further includes an updated prompt to the LLM acting in the role of a data annotator. The example prompt referenced by reference numeral 5 is shown in FIG. 5.

Block 306 encompasses the data annotation phase. In the data annotation phase, the LLM acts as a data annotator, cleaning, and labeling customer data to produce an annotated dataset. The annotated dataset serves as a foundation for further model training. The output of the LLM acting as a data annotator is shown by reference numeral 6 in Block 306, which is annotated clean data that may be used as the training dataset.

Block 308 represents the training phase, where the annotated dataset is used to train the attribute extraction model. The training process includes techniques such as knowledge distillation, in which the LLM's outputs are used to guide the smaller model, and quantization, which optimizes the model for efficient deployment. Together, the aforementioned phases form a feedback loop that continuously improves the performance and accuracy of the deployed attribute extraction model, leveraging the reasoning capabilities of the LLM to enhance instruction tuning, data annotation, and model training.

FIGS. 4 and 5 show examples of the intermediate outputs generated during the reasoning phase, instruction tuning phase and the data annotation phases. The examples of FIGS. 4 and 5 correspond to the reference numerals within the reasoning phase block (304) and the data annotation block (306) shown in FIG. 3. Reference numeral 1 shows the output report generated by the user application, as compiled from user feedback on the predictions, and the original predictions. The sample report, “PR 1152,” shows attributes and the user feedback (“correct,” and “incorrect”).

The report PR 1152, represented by reference numeral 4, may be a report including several pages. Each page is formatted and sent as page wise text to the LLM. Reference numeral 2 corresponds to reference numeral 2 of FIG. 3, shows an example the input sent to the LLM acting as the reasoning engine, and an example prompt sent to the LLM. The prompt assigns a role to the LLM and gives detailed instructions on processing the report “PR 1152”. The prompt directs the LLM to generate the analysis report. Reference numeral 3 corresponds to reference numeral 3 of FIG. 3 and shows an example of the analysis report. The analysis report includes business logic reasons that identify and support/validate the user feedback on the extracted predictions.

Turning to FIG. 5, reference numeral 4 corresponds to reference numeral 4 of FIG. 3. Shown in greater detail, reference numeral 4 includes the input to the LLM acting as an instruction tuner. The input includes an example prompt which assigns a role of instruction tuner to the LLM, and directs the LLM to refine the prompts for extraction of well data, using the analysis reports. The specific inputs include the inputs corresponding to reference numerals 6, 7 and 8, respectively. Reference numeral 6 in FIG. 5 shows an example of a prompt for data annotation. The “original prompt” is the prompt to be refined by the LLM acting as the instruction tuner. Further, the document context, corresponding to reference numeral 7, namely, the original attribute extraction report, is included in the input to the LLM. The analysis report of reference numeral 3 of FIGS. 3, and 4 is also included in the input. More particularly, the input corresponding to reference numeral 8, namely the incorrect predicted attribute values, is processed by the LLM. The output of the LLM acting as the instruction tuner is shown in further detail in the block corresponding to reference numeral 5. Reference numeral 5 corresponds to reference numeral 5 of Block 304 in FIG. 3. The block includes an updated and refined prompt for data annotation, including explanations of the completion date and semantic indicators of the attribute values (“ . . . look for dates that follow the “Reached total depth” date . . . ”) in the prediction report.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 6.1, the computing system (600) may include one or more computer processor(s) (602), non-persistent storage device(s) (604), persistent storage device(s) (606), a communication interface (608) (e.g., Bluetooth interface, infrared interface, network interface, optical interface, etc.), and numerous other elements and functionalities that implement the features and elements of the disclosure. The computer processor(s) (602) may be an integrated circuit for processing instructions. The computer processor(s) (602) may be one or more cores, or micro-cores, of a processor. The computer processor(s) (602) includes one or more processors. The computer processor(s) (602) may include a central processing unit (CPU), a graphics processing unit (GPU), a tensor processing unit (TPU), combinations thereof, etc.

The input device(s) (610) may include a touchscreen, keyboard, mouse, microphone, touchpad, electronic pen, or any other type of input device. The input device(s) (610) may receive inputs from a user that are responsive to data and messages presented by the output device(s) (612). The inputs may include text input, audio input, video input, etc., which may be processed and transmitted by the computing system (600) in accordance with one or more embodiments. The communication interface (608) may include an integrated circuit for connecting the computing system (600) to a network (not shown) (e.g., a local area network (LAN), a wide area network (WAN) such as the Internet, mobile network, or any other type of network) or to another device, such as another computing device, and combinations thereof.

Further, the output device(s) (612) may include a display device, a printer, external storage, or any other output device. One or more of the output device(s) (612) may be the same or different from the input device(s) (610). The input device(s) (610) and output device(s) (612) may be locally or remotely connected to the computer processor(s) (602). Many different types of computing systems exist, and the aforementioned input device(s) (610) and output device(s) (612) may take other forms. The output device(s) (612) may display data and messages that are transmitted and received by the computing system (600). The data and messages may include text, audio, video, etc., and include the data and messages described above in the other figures of the disclosure.

Software instructions in the form of computer-readable program code to perform embodiments may be stored, in whole or in part, temporarily or permanently, on a non-transitory computer-readable medium such as a solid state drive (SSD), compact disk (CD), digital video disk (DVD), storage device, a diskette, a tape, flash memory, physical memory, or any other computer-readable storage medium. Specifically, the software instructions may correspond to computer-readable program code that, when executed by the computer processor(s) (602), is configured to perform one or more embodiments, which may include transmitting, receiving, presenting, and displaying data and messages described in the other figures of the disclosure.

The computing system (600) in FIG. 6.1 may be connected to, or be a part of, a network. For example, as shown in FIG. 6.2, the network (620) may include multiple nodes (e.g., node X (622) and node Y (624), as well as extant intervening nodes between node X (622) and node Y (624)). Each node may correspond to a computing system, such as the computing system shown in FIG. 6.1, or a group of nodes combined may correspond to the computing system shown in FIG. 6.1. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (600) may be located at a remote location and connected to the other elements over a network.

The nodes (e.g., node X (622) and node Y (624)) in the network (620) may be configured to provide services for a client device (626). The services may include receiving requests and transmitting responses to the client device (626). For example, the nodes may be part of a cloud computing system. The client device (626) may be a computing system, such as the computing system shown in FIG. 6.1. Further, the client device (626) may include or perform all or a portion of one or more embodiments.

The computing system of FIG. 6.1 may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
receiving, by a large language model (LLM), a prediction set, and a corresponding binary feedback label set, wherein the prediction set is extracted at least from a raw data source, and the corresponding binary feedback label set comprises binary feedback labels labeling respective predictions of the prediction set;
generating, by the LLM, an explanation of a binary feedback label of a prediction, using the prediction and the raw data source from which the prediction is extracted to obtain an explanation set corresponding to the prediction set;
generating, by the LLM, a set of attribute extraction instructions, using the explanation set and the prediction set, wherein the set of attribute extraction instructions includes attribute extraction instructions across a plurality of raw data sources comprising the raw data source;
generating, by the LLM, a training instance from the set of attribute extraction instructions;
annotating the training instance with an output probability distribution corresponding to the training instance, to obtain an annotated training dataset;
training an attribute extraction model with the annotated training dataset, to obtain a trained attribute extraction model; and
deploying the trained attribute extraction model.

2. The method of claim 1, further comprising:
generating, by a previously deployed instance of the attribute extraction model, a prediction comprising an attribute and a corresponding attribute value.

3. The method of claim 1, further comprising:
presenting a prediction in a user application;
obtaining a binary feedback label corresponding to the prediction, comprising a correct label and an error label;
obtaining a feedback summary corresponding to the prediction; and
storing the prediction, the binary feedback label, and the feedback summary in a data repository.

4. The method of claim 1, further comprising:
generating a prompt to the LLM, comprising the prediction set, the corresponding binary feedback label set, and the raw data source as input, and an instruction to generate the explanation set using the input; and
processing, by the LLM, the prompt, to generate the explanation set.

5. The method of claim 1, further comprising:
obtaining a plurality of explanation sets, comprising explanation sets corresponding to the plurality of raw data sources, from which the prediction set is extracted; and
aggregating explanations of the plurality of explanation sets by individual predictions of the prediction set, to obtain a plurality of second explanation sets, each second explanation set corresponding to a prediction of the prediction set.

6. The method of claim 5, further comprising:
generating a prompt to the LLM, comprising the plurality of second explanation sets, the prediction set, and the plurality of raw data sources as input, and an instruction to generate attribute extraction instructions corresponding to attributes of individual predictions of the set of predictions; and
processing, by the LLM, the prompt, to generate the set of attribute extraction instructions.

7. The method of claim 1, further comprising:
processing, by the LLM, an attribute extraction instruction by performing operations comprising:
extracting the training instance comprising a training attribute and a corresponding training attribute value, from the plurality of raw data sources, and
generating reference metadata corresponding to the training instance, comprising locations in raw data sources of the plurality of raw data sources from which the training instance is extracted, to obtain the annotated training dataset.

8. The method of claim 7, further comprising:
retrieving, from the LLM, the output probability distribution corresponding to the training instance, wherein the output probability distribution is a vector of probabilities of the corresponding training attribute value corresponding to the training attribute; and
adding the output probability distribution to the training instance, to obtain the annotated training dataset.

9. The method of claim 1, further comprising:
training the attribute extraction model by performing operations comprising:
inputting, to the attribute extraction model, a training attribute and corresponding reference metadata of the training attribute, wherein the training attribute and the corresponding reference metadata are obtained from the training instance;
obtaining, from the attribute extraction model, a predicted attribute value; and
computing a loss function of the predicted attribute value and a training attribute value corresponding to the training attribute to obtain a loss function value.

10. The method of claim 9, further comprising:
obtaining, from the training instance, a target output probability distribution;
computing a divergence function between the target output probability distribution and an output probability distribution of the attribute extraction model corresponding to the predicted attribute value, to obtain a divergence function value;
combining the loss function value and the divergence function value to obtain a combined loss function value; and
updating parameters of the attribute extraction model by backpropagating gradients computed from the combined loss function value through a plurality of layers of the attribute extraction model using a gradient-based optimization function.

11. A system comprising:
at least one computer processor;
a large language model (LLM), executing on the at least one computer processor;
an attribute extraction model, executing on the at least one computer processor;
a training application, executing on the at least one computer processor; and
an artificial intelligence (AI) agent executing on the at least one computer processor and configured for:
retrieving a prediction set and a corresponding binary feedback label set, wherein the prediction set is extracted at least from a raw data source, and the corresponding binary feedback label set comprises binary feedback labels labeling respective predictions of the prediction set,
causing the LLM to generate an explanation of a binary feedback label of a prediction, using the prediction and the raw data source from which the prediction is extracted to obtain an explanation set corresponding to the prediction set,
causing the LLM to generate a set of attribute extraction instructions, using the explanation set and the prediction set, wherein the set of attribute extraction instructions includes attribute extraction instructions across a plurality of raw data sources comprising the raw data source,
causing the LLM to generate, a training instance from the set of attribute extraction instructions, and
annotating the training instance with an output probability distribution of the training instance corresponding to the training instance, to obtain an annotated training dataset; and
wherein the training application is configured for:
training the attribute extraction model with the annotated training dataset.

12. The system of claim 11, further comprising a user application executing on the at least one computer processor, and configured for:
presenting the prediction in a user interface;
obtaining a binary feedback label corresponding to the prediction;
obtaining a feedback summary corresponding to the prediction; and
storing the prediction, the binary feedback label, and the feedback summary in a data repository; and
wherein the attribute extraction model is configured for:
generating the prediction, comprising an attribute and a corresponding attribute value.

13. The system of claim 11, wherein the AI agent is further configured for:
generating a prompt to the LLM, comprising the prediction set, the raw data source, and the binary feedback label set as input, and an instruction to generate the explanation set using the input; and
processing, by the LLM, the prompt, to generate the explanation set.

14. The system of claim 11, wherein the AI agent is further configured for:
obtaining a plurality of explanation sets, comprising explanation sets corresponding to the plurality of raw data sources, from which the prediction set is extracted;
aggregating explanations of the plurality of explanation sets by individual predictions of the prediction set, to obtain a plurality of second explanation sets, each second explanation set corresponding to a prediction of the prediction set;
generating a prompt to the LLM, comprising the plurality of second explanation sets, the prediction set, and the plurality of raw data sources as input, and an instruction to generate attribute extraction instructions corresponding to attributes of individual predictions of the set of predictions; and
invoking the LLM to process the prompt, to generate the set of attribute extraction instructions.

15. The system of claim 11, further configured for:
processing, by the LLM, an attribute extraction instruction by performing operations comprising:
extracting the training instance comprising a training attribute and a corresponding training attribute value, from the plurality of raw data sources, and
generating reference metadata corresponding to the training instance, comprising locations in raw data sources of the plurality of raw data sources from which the training instance is extracted, to obtain the annotated training dataset.

16. The system of claim 15, wherein the AI agent is further configured for:
retrieving, from the LLM, an output probability distribution corresponding to the training instance, wherein the output probability distribution is a vector of probabilities of the corresponding training attribute value corresponding to the training attribute; and
adding the output probability distribution to the training instance, to obtain the annotated training dataset.

17. The system of claim 11, wherein the training application is further configured for:
training the attribute extraction model by performing operations comprising:
inputting, to the attribute extraction model, a training attribute and corresponding reference metadata of the training attribute, wherein the training attribute and the corresponding reference metadata are obtained from the training instance,
obtaining, from the attribute extraction model, a predicted attribute value, and
computing a loss function of the predicted attribute value and a training attribute value corresponding to the training attribute to obtain a loss function value.

18. The system of claim 17, wherein the training application is further configured for:
obtaining, from the training instance, a target output probability distribution;
computing a divergence function between the target output probability distribution and an output probability distribution of the attribute extraction model corresponding to the predicted attribute value, to obtain a divergence function value;
combining the loss function value and the divergence function value to obtain a combined loss function value; and
updating parameters of the attribute extraction model by backpropagating gradients computed from the combined loss function value through a plurality of layers of the attribute extraction model using a gradient-based optimization function.

19. A non-transitory computer-readable medium storing instructions executable by at least one computer processor to perform operations comprising:
retrieving, by an artificial intelligence (AI) agent, a prediction set and a corresponding binary feedback label set, wherein the prediction set is extracted at least from a raw data source, and the corresponding binary feedback label set comprises binary feedback labels labeling respective predictions of the prediction set;
invoking, by the AI agent, a large language model (LLM) to generate an explanation of a binary feedback label of a prediction, using the prediction and the raw data source from which the prediction is extracted to obtain an explanation set corresponding to the prediction set;
invoking, by the AI agent, the LLM, to generate a set of attribute extraction instructions, using the explanation set and the prediction set, wherein the set of attribute extraction instructions includes attribute extraction instructions across a plurality of raw data sources comprising the raw data source;
invoking, by the AI agent, the LLM, to generate a training instance from the set of attribute extraction instructions;
annotating, by the AI agent, the training instance with an output probability distribution of the training instance corresponding to the training instance, to obtain an annotated training dataset; and
training, by a training application, an attribute extraction model with the annotated training dataset.

20. The non-transitory computer-readable medium of claim 19, wherein the operations further comprise:
inputting, to the attribute extraction model, a training attribute and corresponding reference metadata of the training attribute, wherein the training attribute and the corresponding reference metadata are obtained from a training instance;
obtaining, from the attribute extraction model, a predicted attribute value;
computing a loss function of the predicted attribute value and a training attribute value corresponding to the training attribute to obtain a loss function value;
obtaining, from the training instance, a target output probability distribution;
computing a divergence function between the target output probability distribution and an output probability distribution of the attribute extraction model corresponding to the predicted attribute value, to obtain a divergence function value;
combining the loss function value and the divergence function value to obtain a combined loss function value; and
updating parameters of the attribute extraction model by backpropagating gradients computed from the combined loss function value through a plurality of layers of the attribute extraction model using a gradient-based optimization function.
